(19) United States
(12) Patent Application Publication
(10) Pub. No.: US 2015/0261524 A1
(43) Pub. Date: Sep. 17, 2015

(54) MANAGEMENT PACK SERVICE MODEL FOR MANAGED CODE FRAMEWORK

(71) Applicant: NetApp Inc., Sunnyvale, CA (US)

(72) Inventors: Stephanie Zhimao He, Fremont, CA (US); Dennis Lalchan Ramdass, Mountain View, CA (US)

(73) Assignee: NetApp Inc., Sunnyvale, CA (US)

(21) Appl. No.: 14/213,461

(22) Filed: Mar. 14, 2014

(51) Int. Cl. G06F 9/44

(52) U.S. Cl. CPC G06F 8/70

(57) ABSTRACT

One or more techniques and/or systems are provided for generating a class based upon a management pack and/or for generating a management pack based upon a class. For example, a management pack may comprise an object definition of an object that may be monitored by an operating system monitoring component (e.g., a storage device object may be stored within a database by the operating system monitoring component for monitoring of a storage device). The object definition may be extracted from the management pack and may be used to generate a class for the object. Fields, properties, methods, relationships, and/or other information may be generated for inclusion within the class based upon the object definition. The class may be formatted according to a managed code programming language (e.g., C#) and/or exposed through a software programming framework (e.g., .NET).

### BACKGROUND

An operating system monitoring component may be configured to monitor various objects, such as storage devices, network devices, a storage operating system, a storage controller, storage functionality (e.g., a storage API, a storage application, a data replication application, etc.), software, hardware, etc. The operating system monitoring component may store information about such objects within a database (e.g., as database objects). A management pack may comprise an object definition that models an object utilizing a markup language, such as XML. The operating system monitoring component utilizes the management pack to create a database object for the object, such as for inclusion within the database.

### DESCRIPTION OF THE DRAWINGS

FIG. 1 is a component block diagram illustrating an example clustered network in accordance with one or more of the provisions set forth herein.

FIG. 2 is a component block diagram illustrating an example data storage system in accordance with one or more of the provisions set forth herein.

FIG. 3 is a flow chart illustrating an exemplary method of generating a class.

FIG. 4 is a component block diagram illustrating an exemplary system for generating a class.

FIG. 5 is a component block diagram illustrating an exemplary system for utilizing one or more classes generated from management packs.

FIG. 6 is a flow chart illustrating an exemplary method of generating a management pack.

FIG. 7 is a component block diagram illustrating an exemplary system for generating a management pack.

FIG. 8 is an example of a computer readable medium in accordance with one or more of the provisions set forth herein.

FIG. 9 illustrates an exemplary computing environment wherein one or more of the provisions set forth herein may be implemented.

### DETAILED DESCRIPTION

Some examples of the claimed subject matter are now described with reference to the drawings, where like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. Nothing in this detailed description is admitted as prior art.

One or more systems and/or techniques for generating a class from a management pack and/or for generating a management pack from a class are provided. A management pack may be created by a vendor (e.g., a manufacture of a storage device) to describe an object (e.g., the storage device) that may be monitored by an operating system monitoring component or any other monitoring component/functionality (e.g., the operating system monitoring component may store the object within a database as a database object). The management pack may comprise an object definition that models the object. In an example, the object definition may be specified in a markup language such as XML. The object definition may be extracted from the management pack (e.g., utilizing an XML parser configured to identify properties, relationships, and/or other information associated with objects).

A class may be generated for the object based upon the object definition (e.g., a storage device class). Fields, class properties, methods, relationships, and/or other information may be generated for inclusion within the class based upon the object definition (e.g., the storage device class may comprise a display name field, a volume property, a get storage device status method, etc.). The class may be exposed through a software programming framework (e.g., a managed code framework such as .NET) so that a developer may access the database object through the class (e.g., the class may be used to generate a database query to access the database object representing the object within the database). Similarly, a management pack may be generated based upon a class (e.g., a class definition may be extracted from a class, and the class definition may be used to generate a management pack).

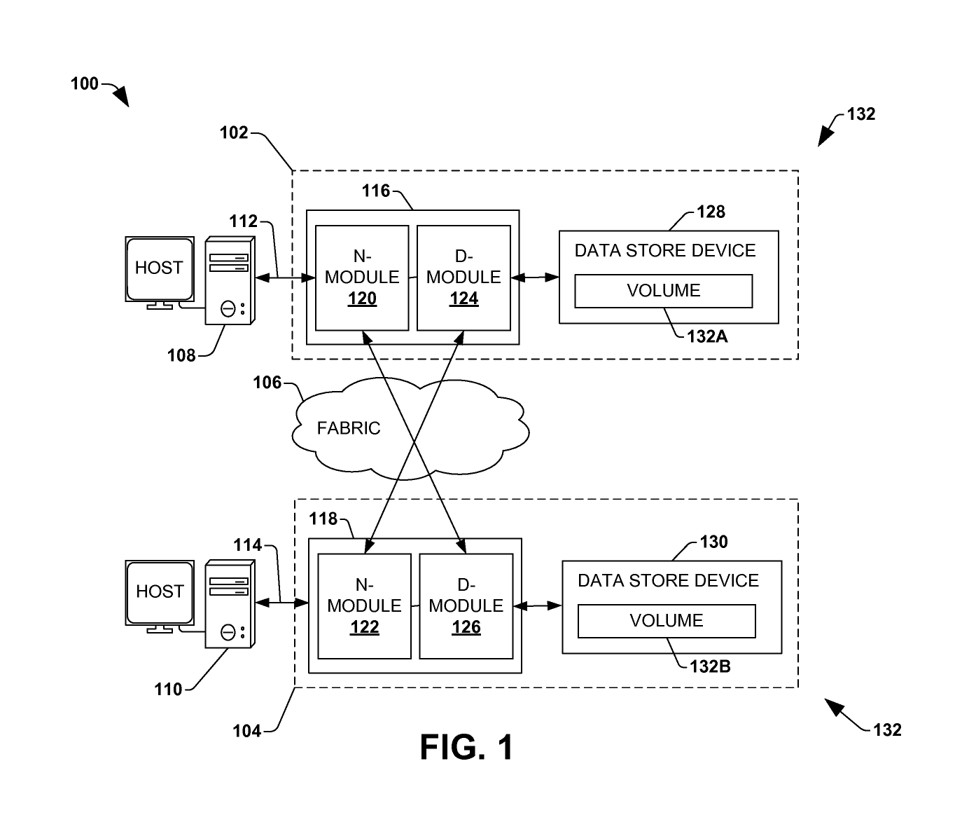

To provide context for generating a class and/or a management pack, FIG. 1 illustrates an embodiment of a clustered network environment 100. It may be appreciated, however, that the techniques, etc. described herein may be implemented within the clustered network environment 100, a non-cluster network environment, and/or a variety of other computing environments, such as a desktop computing environment. That is, the instant disclosure, including the scope of the appended claims, is not meant to be limited to the examples provided herein. It will be appreciated that where the same or similar components, elements, features, items, modules, etc. are illustrated in later figures but were previously discussed with regard to prior figures, that a similar (e.g., redundant) discussion of the same may be omitted when describing the subsequent figures (e.g., for purposes of simplicity and ease of understanding).

FIG. 1 is a block diagram illustrating an example clustered network environment 100 that may implement at least some embodiments of the techniques and/or systems described herein. The example environment 100 comprises data storage systems or storage sites 102 and 104 that are coupled over a cluster fabric 106, such as a computing network embodied as a private Infiniband or Fibre Channel (FC) network facilitating communication between the storage systems 102 and 104 (and one or more modules, component, etc. therein, such as, nodes 116 and 118, for example). It will be appreciated that while two data storage systems 102 and 104 and two nodes 116 and 118 are illustrated in FIG. 1, that any suitable number of such components is contemplated. In an example, nodes 116, 118 comprise storage controllers (e.g., node 116 may comprise a primary or local storage controller and node 118 may comprise a secondary or remote storage controller) that provide client devices, such as host devices 108, 110, with access to data stored within data storage devices 128, 130. Similarly, unless specifically provided otherwise herein, the same is true for other modules, elements, features, items, etc. referenced herein and/or illustrated in the accompanying drawings. That is, a particular number of components, modules, elements, features, items, etc. disclosed herein is not meant to be interpreted in a limiting manner.

It will be further appreciated that clustered networks are not limited to any particular geographic areas and can be clustered locally and/or remotely. Thus, in one embodiment a clustered network can be distributed over a plurality of storage systems and/or nodes located in a plurality of geographic locations; while in another embodiment a clustered network can include data storage systems (e.g., 102, 104) residing in a same geographic location (e.g., in a single onsite rack of data storage devices).

In the illustrated example, one or more host devices 108, 110 which may comprise, for example, client devices, personal computers (PCs), computing devices used for storage (e.g., storage servers), and other computers or peripheral devices (e.g., printers), are coupled to the respective data storage systems 102, 104 by storage network connections 112, 114. Network connection may comprise a local area network (LAN) or wide area network (WAN), for example, that utilizes Network Attached Storage (NAS) protocols, such as a Common Internet File System (CIFS) protocol or a Network File System (NFS) protocol to exchange data packets. Illustratively, the host devices 108, 110 may be general-purpose computers running applications, and may interact with the data storage systems 102, 104 using a client/server model for exchange of information. That is, the host device may request data from the data storage system (e.g., data on a storage device managed by a network storage control configured to process I/O commands issued by the host device for the storage device), and the data storage system may return results of the request to the host device via one or more network connections 112, 114.

The nodes 116, 118 on clustered data storage systems 102, 104 can comprise network or host nodes that are interconnected as a cluster to provide data storage and management services, such as to an enterprise having remote locations, for example. Such a node in a data storage and management network cluster environment 100 can be a device attached to the network as a connection point, redistribution point or communication endpoint, for example. A node may be capable of sending, receiving, and/or forwarding information over a network communications channel, and could comprise any device that meets any or all of these criteria. One example of a node may be a data storage and management server attached to a network, where the server can comprise a general purpose computer or a computing device particularly configured to operate as a server in a data storage and management system.

As illustrated in the exemplary environment 100, nodes 116, 118 can comprise various functional components that coordinate to provide distributed storage architecture for the cluster. For example, the nodes can comprise a network module 120, 122 (e.g., N-Module, or N-Blade) and a data module 124, 126 (e.g., D-Module, or D-Blade). Network modules 120, 122 can be configured to allow the nodes 116, 118 (e.g., network storage controllers) to connect with host devices 108, 110 over the network connections 112, 114, for example, allowing the host devices 108, 110 to access data stored in the distributed storage system. Further, the network modules 120, 122 can provide connections with one or more other components through the cluster fabric 106. For example, in FIG. 1, a first network module 120 of first node 116 can access a second data storage device 130 by sending a request through a second data module 126 of a second node 118.

Data modules 124, 126 can be configured to connect one or more data storage devices 128, 130, such as disks or arrays of disks, flash memory, or some other form of data storage, to the nodes 116, 118. The nodes 116, 118 can be interconnected by the cluster fabric 106, for example, allowing respective nodes in the cluster to access data on data storage devices 128, 130 connected to different nodes in the cluster. Often, data modules 124, 126 communicate with the data storage devices 128, 130 according to a storage area network (SAN) protocol, such as Small Computer System Interface (SCSI) or Fiber Channel Protocol (FCP), for example. Thus, as seen from an operating system on a node 116, 118, the data storage devices 128, 130 can appear as locally attached to the operating system. In this manner, different nodes 116, 118, etc. may access data blocks through the operating system, rather than expressly requesting abstract files.

It should be appreciated that, while the example embodiment 100 illustrates an equal number of N and D modules, other embodiments may comprise a differing number of these modules. For example, there may be a plurality of N and/or D modules interconnected in a cluster that does not have a one-to-one correspondence between the N and D modules. That is, different nodes can have a different number of N and D modules, and the same node can have a different number of N modules than D modules.

Further, a host device 108, 110 can be networked with the nodes 116, 118 in the cluster, over the networking connections 112, 114. As an example, respective host devices 108, 110 that are networked to a cluster may request services (e.g., exchanging of information in the form of data packets) of a node 116, 118 in the cluster, and the node 116, 118 can return results of the requested services to the host devices 108, 110. In one embodiment, the host devices 108, 110 can exchange information with the network modules 120, 122 residing in the nodes (e.g., network hosts) 116, 118 in the data storage systems 102, 104.

In one embodiment, the data storage devices 128, 130 comprise volumes 132, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume.

Volumes are typically configured in formats that may be associated with particular storage systems, and respective volume formats typically comprise features that provide functionality to the volumes, such as providing an ability for volumes to form clusters. For example, where a first storage system may utilize a first format for their volumes, a second storage system may utilize a second format for their volumes.

In the example environment 100, the host devices 108, 110 can utilize the data storage systems 102, 104 to store and retrieve data from the volumes 132. In this embodiment, for example, the host device 108 can send data packets to the N-module 120 in the node 116 within data storage system 102. The node 116 can forward the data to the data storage device 128 using the D-module 124, where the data storage device 128 comprises volume 132A. In this way, in this example, the host device can access the storage volume 132A, to store and/or retrieve data, using the data storage system 102 connected by the network connection 112. Further, in this embodiment, the host device 110 can exchange data with the N-module 122 in the host 118 within the data storage system 104 (e.g., which may be remote from the data storage system 102). The host 118 can forward the data to the data storage device 130 using the D-module 126, thereby accessing volume 132B associated with the data storage device 130.

It may be appreciated that class generation and/or management pack generation may be implemented within the clustered network environment 100. For example, a class generation component configured to generate a class and/or a management pack generation component configured to generate a management pack may be hosted on host devices 108,110. In an example, a data storage device class and/or a data storage device management pack may be generated to describe the data storage devices 128,130.

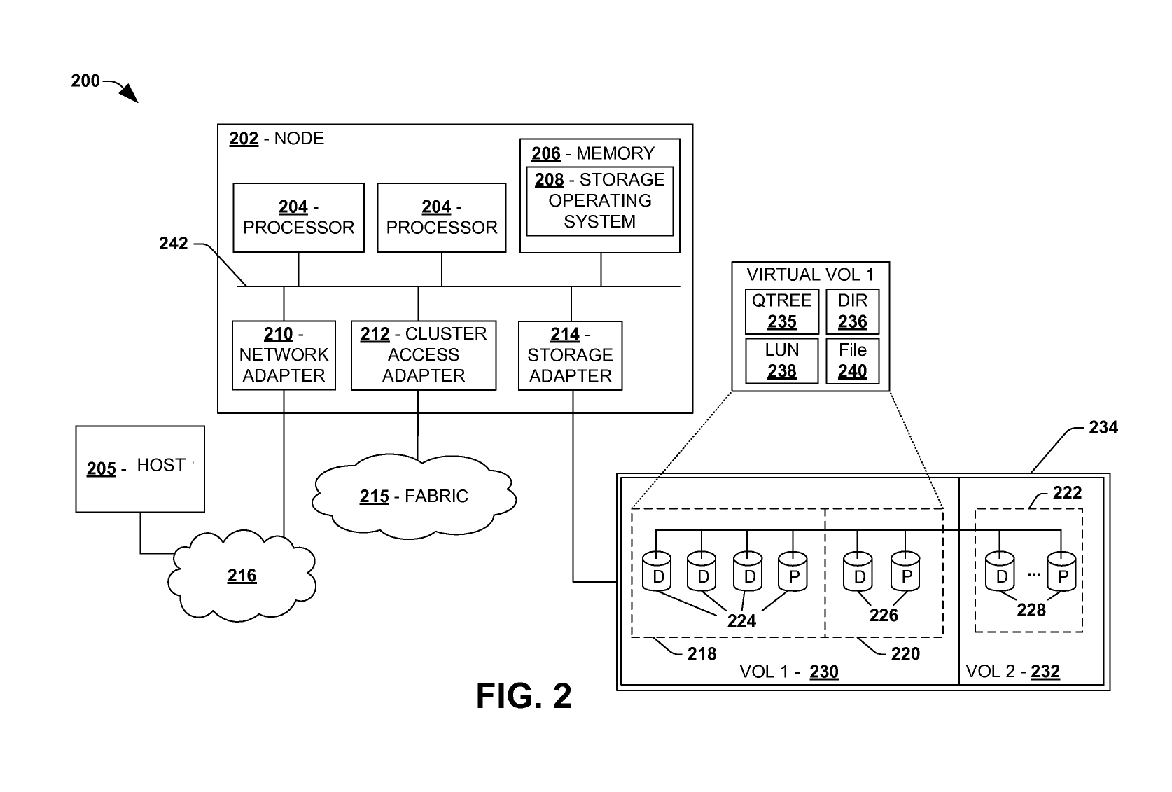

FIG. 2 is an illustrative example of a data storage system or storage site 200 (e.g., 102, 104 in FIG. 1), providing further detail of an embodiment of components that may implement one or more of the techniques and/or systems described herein. The example data storage system 200 comprises a node 202 (e.g., host nodes 116, 118 in FIG. 1), and a data storage device 234 (e.g., data storage devices 128, 130 in FIG. 1). The node 202 may be a general purpose computer, for example, or some other computing device particularly configured to operate as a storage server. A host device 205 (e.g., 108, 110 in FIG. 1) can be connected to the node 202 over a network 216, for example, to provides access to files and/or other data stored on the data storage device 234. In an example, the node 202 comprises a storage controller that provides client devices, such as the host device 205, with access to data stored within data storage device 234.

The data storage device 234 can comprise mass storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information.

The node 202 comprises one or more processors 204, a memory 206, a network adapter 210, a cluster access adapter 212, and a storage adapter 214 interconnected by a system bus 242. The storage system 200 also includes an operating system 208 installed in the memory 206 of the node 202 that can, for example, implement a Redundant Array of Independent (or Inexpensive) Disks (RAID) optimization technique to optimize a reconstruction process of data of a failed disk in an array.

The operating system 208 can also manage communications for the data storage system, and communications between other data storage systems that may be in a clustered network, such as attached to a cluster fabric 215 (e.g., 106 in FIG. 1). Thus, the node 202, such as a network storage controller, can respond to host device requests to manage data on the data storage device 234 (e.g., or additional clustered devices) in accordance with these host device requests. The operating system 208 can often establish one or more file systems on the data storage system 200, where a file system can include software code and data structures that implement a persistent hierarchical namespace of files and directories, for example. As an example, when a new data storage device (not shown) is added to a clustered network system, the operating system 208 is informed where, in an existing directory tree, new files associated with the new data storage device are to be stored. This is often referred to as “mounting” a file system.

In the example data storage system 200, memory 206 can include storage locations that are addressable by the processors 204 and adapters 210, 212, 214 for storing related software program code and data structures. The processors 204 and adapters 210, 212, 214 may, for example, include processing elements and/or logic circuitry configured to execute the software code and manipulate the data structures. The operating system 208, portions of which are typically resident in the memory 206 and executed by the processing elements, functionally organizes the storage system by, among other things, invoking storage operations in support of a file service implemented by the storage system. It will be apparent to those skilled in the art that other processing and memory mechanisms, including various computer readable media, may be used for storing and/or executing program instructions pertaining to the techniques described herein. For example, the operating system can also utilize one or more control files (not shown) to aid in the provisioning of virtual machines.

The network adapter 210 includes the mechanical, electrical and signaling circuitry needed to connect the data storage system 200 to a host device 205 over a computer network 216, which may comprise, among other things, a point-to-point connection or a shared medium, such as a local area network. The host device 205 (e.g., 108, 110 of FIG. 1) may be a general-purpose computer configured to execute applications. As described above, the host device 205 may interact with the data storage system 200 in accordance with a client/host model of information delivery.

The storage adapter 214 cooperates with the operating system 208 executing on the node 202 to access information requested by the host device 205 (e.g., access data on a storage device managed by a network storage controller). The information may be stored on any type of attached array of writeable media such as magnetic disk drives, flash memory, and/or any other similar media adapted to store information. In the example data storage system 200, the information can be stored in data blocks on the disks 224, 226, 228. The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fiber Channel Protocol (FCP)). The information is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the host device 205 over the network connection 216 (and/or returned to another node attached to the cluster over the cluster fabric 215).

In one embodiment, storage of information on arrays 218, 220, 222 can be implemented as one or more storage “volumes” 230, 232 that are comprised of a cluster of disks 224, 226, 228 defining an overall logical arrangement of disk space. The disks 224, 226, 228 that comprise one or more volumes are typically organized as one or more groups of RAIDs. As an example, volume 230 comprises an aggregate of disk arrays 218 and 220, which comprise the cluster of disks 224 and 226.

In one embodiment, to facilitate access to disks 224, 226, 228, the operating system 208 may implement a file system (e.g., write anywhere file system) that logically organizes the information as a hierarchical structure of directories and files on the disks. In this embodiment, respective files may be implemented as a set of disk blocks configured to store information, whereas directories may be implemented as specially formatted files in which information about other files and directories are stored.

Whatever the underlying physical configuration within this data storage system 200, data can be stored as files within physical and/or virtual volumes, which can be associated with respective volume identifiers, such as file system identifiers (FSIDs), which can be 32-bits in length in one example.

A physical volume, which may also be referred to as a “traditional volume” in some contexts, corresponds to at least a portion of physical storage devices whose address, addressable space, location, etc. doesn't change, such as at least some of one or more data storage devices 234 (e.g., a Redundant Array of Independent (or Inexpensive) Disks (RAID system)). Typically the location of the physical volume doesn't change in that the (range of) address(es) used to access it generally remains constant.

A virtual volume, in contrast, is stored over an aggregate of disparate portions of different physical storage devices. The virtual volume may be a collection of different available portions of different physical storage device locations, such as some available space from each of the disks 224, 226, and/or 228. It will be appreciated that since a virtual volume is not “tied” to any one particular storage device, a virtual volume can be said to include a layer of abstraction or virtualization, which allows it to be resized and/or flexible in some regards.

Further, a virtual volume can include one or more logical unit numbers (LUNs) 238, directories 236, qtrees 235, and files 240. Among other things, these features, but more particularly LUNS, allow the disparate memory locations within which data is stored to be identified, for example, and grouped as data storage unit. As such, the LUNs 238 may be characterized as constituting a virtual disk or drive upon which data within the virtual volume is stored within the aggregate. For example, LUNs are often referred to as virtual drives, such that they emulate a hard drive from a general purpose computer, while they actually comprise data blocks stored in various parts of a volume.

In one embodiment, one or more data storage devices 234 can have one or more physical ports, wherein each physical port can be assigned a target address (e.g., SCSI target address). To represent respective volumes stored on a data storage device, a target address on the data storage device can be used to identify one or more LUNs 238. Thus, for example, when the node 202 connects to a volume 230, 232 through the storage adapter 214, a connection between the node 202 and the one or more LUNs 238 underlying the volume is created.

In one embodiment, respective target addresses can identify multiple LUNs, such that a target address can represent multiple volumes. The I/O interface, which can be implemented as circuitry and/or software in the storage adapter 214 or as executable code residing in memory 206 and executed by the processors 204, for example, can connect to volume 230 by using one or more addresses that identify the LUNs 238.

It may be appreciated that class generation and/or management pack generation may be implemented within the data storage system 200. For example, a class generation component configured to generate a class and/or a management pack generation component configured to generate a management pack may be hosted on host device 205. In an example, a data storage class and/or a data storage management pack may be generated to describe the data storage device 234.

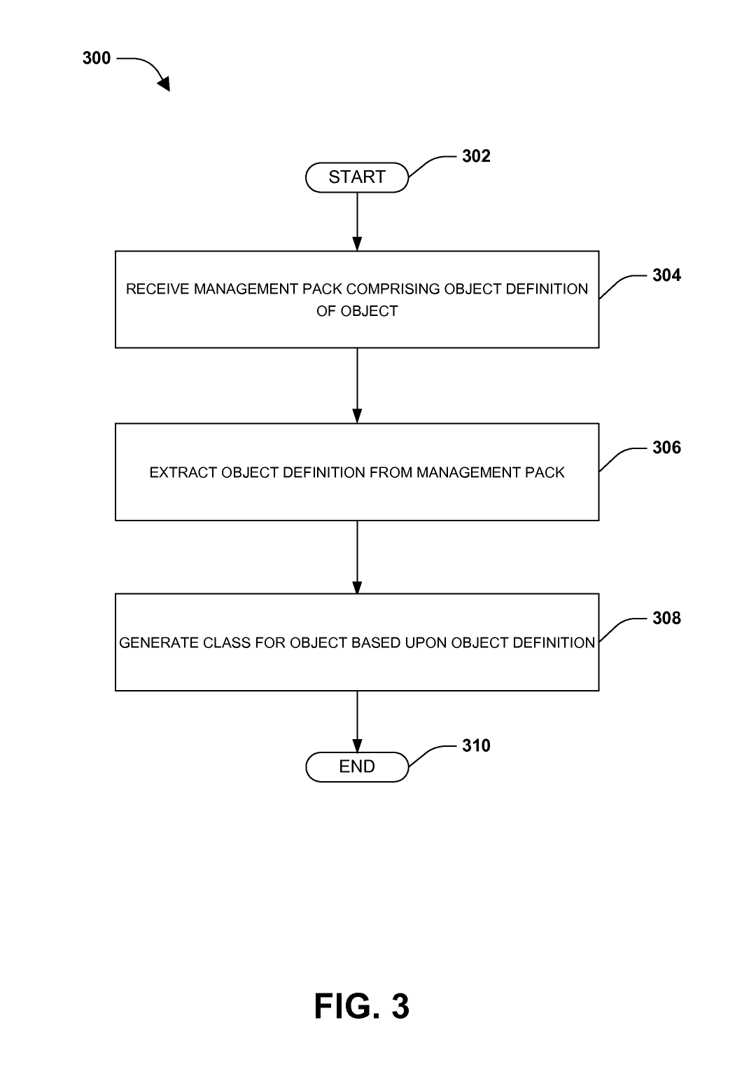

One embodiment of generating a class is illustrated by an exemplary method 300 of FIG. 3. At 302, the method starts. At 304, a management pack comprising an object definition of an object may be received (e.g., the management pack may describe a storage device object representing a physical storage device). The management pack may be used by an operating system monitoring component to represent the object within a database (e.g., as a storage device database object). The operating system monitoring component may be configured to monitor the physical storage device and/or update the storage device database object with information regarding the physical storage device (e.g., a power on/off status of the physical storage device may be specified within the storage device database object). At 306, an object definition may be extracted from the management pack. In an example, the management pack may be formatted according to a markup language (e.g., XML) such that the object definition may be extracted by parsing the makeup language to extract one or more object properties (e.g., a volume property, a size property, a speed property, etc.) as the object definition. In this way, one or more object properties of the object may be enumerated as the object definition.

At 308, a class may be generated for the object based upon the object definition. The class may be generated according to a managed code programming language (e.g., a C# class or any other programming language class). In an example, one or more object properties of the object definition may be used to generate a field, a class property, a method, a relationship, and/or other information for inclusion within the class (e.g., a volume object property may be used to generate a volume class property; a size object property may be used to generate a size field; etc.). In an example, an insertion method (e.g., used to insert information regarding the physical storage device into the storage device database object stored within the database that is maintained by the operating system monitoring component), a deletion method, a validation method, and/or any other type of method may be generated for inclusion within the class.

In an example, one or more key values within the management pack may be preserved when generating the class. For example, a key value specified by the object definition may be identified (e.g., a storage device name may be identified as a key value because the storage device name may be used to provide an identity for the storage device object). A set key value method may be generated for inclusion within the class based upon the key value (e.g., the set key value method may be invoked to provide a storage device name for the storage device class).

In an example, naming collisions between object properties within the object definition and keywords of the managed code programming language may be mitigated. For example, responsive to identifying a naming collision (e.g., an object property within the object definition may have a naming collision, such as a conflict, with a managed code programming language keyword), a prefix may be added to at least one of a field, a class property, or a method comprised within the class to resolve the naming collision (e.g., a prefix mc_{—} may be added to destination path field created based upon a destination path object property that is in conflict with a destination path keyword of the managed code programming language).

In an example, a library may be generated based upon the class and/or other classes derived from the management pack (e.g., a storage controller class, a data mirroring class, etc.). In an example, legacy objects may be preserved within the library. For example, a legacy object having a legacy object definition within the management pack may be identified (e.g., a data backup object associated with data backup functionality for the storage device object). The legacy object may be preserved within the library, such that a class is not created for the legacy object. In this way, the library may comprise classes and/or legacy objects.

In an example, the management pack may be validated based upon a configuration markup file. The configuration markup file may provide class generation configuration settings used to generate the class (e.g., a namespace, how to define a relationship between objects, an object for which a class is to be created, etc.) and/or validation information (e.g., a naming convention associated with the managed code programming language, which may be enforced during generation of the class).

Compile-time type checking, safe object passing, inheritance, and/or encapsulation may be performed for the class. In an example, a determination may be made that the object has a relationship with a second object defined by a second object definition within the management pack (e.g., the first object hosts the second object, the first object comprises the second object, etc.). The second object definition may be extracted from the management pack. A second class may be generated for the second object based upon the second object definition. A relationship rule may be specified between the class and the second class, such as an inheritance rule and/or an encapsulation rule. In another example, a determination may be made that the management pack references a second management pack (e.g., the storage device management pack may reference a storage network communication management pack). A third object definition may be extracted from the second management pack (e.g., a storage network object definition of a storage network object may be extracted). A third class may be generated for a third object (e.g., the storage network object) based upon the third object definition (e.g., a storage network class may be created). A relationship rule may be specified between the class and the third class.

In an example, the class may be exposed through a software programming framework (e.g., .NET). In an example, a library comprising the class and/or other classes derived from the management pack and/or other management packs may be exposed through the software programming framework. In this way, a programmer may utilize the class (e.g., using a managed code programming language, such as C#, which may be familiar to the programmer) to access the object stored within the database (e.g., as a database object) by the operating system monitoring component. For example, the class may be utilized to generate a database query to access the database object. At 310, the method ends.

In one embodiment of utilizing a class, a class may be accessed through a software programming framework. The class may comprise a class definition for an object, such as a storage operating system. The class definition may have been derived from an object definition, within a management pack, defining the object. The class may be utilized to access monitoring information associated with the object (e.g., an application may be generated through the software programming framework, and the application may utilize the class to access a database comprising the monitoring information for the storage operating system). In this way, the storage operating system may be monitored (e.g., performance, operations, usage, etc.) based upon the monitoring information that is accessible through the class.

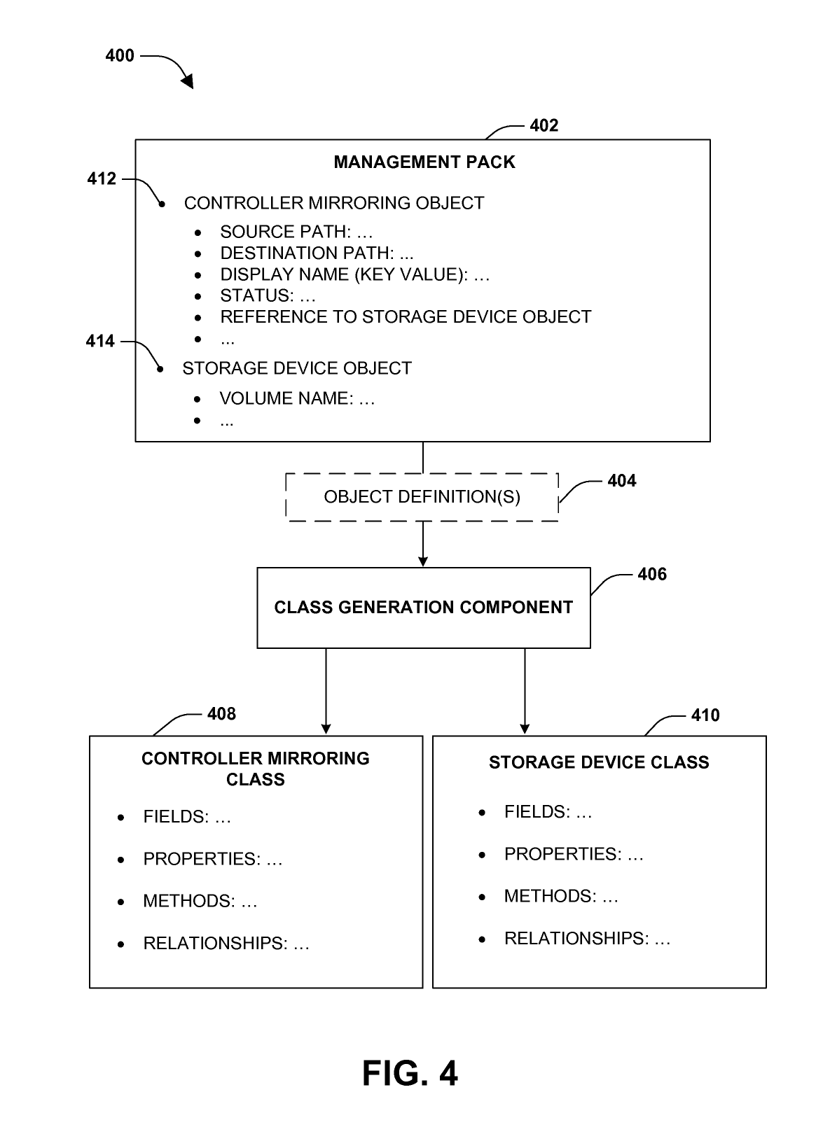

FIG. 4 illustrates an example of a system 400 for generating a class. The system 400 comprises a class generation component 406. The class generation component 406 may be configured to receive a management pack 402. The management pack 402 may comprise a controller mirroring object definition 412 for a controller mirroring object, a storage device object definition 414 for a storage device object, and/or other object definitions of objects that may be monitored by an operating system monitoring component or other monitoring component/functionality.

The class generation component 406 may be configured to extract 404 the controller mirroring object definition 412 and/or the storage device object definition 414. In an example, one or more object properties (e.g., a source path object property, a destination path object property, a display name object property, a status object property, etc.), relationship information (e.g., a reference to the storage device object), and/or other information (e.g., identification of the display name object property being a key value) may be extracted from the controller mirroring object definition 412 by the class generation component 406 for generation of a controller mirroring class 408. In this way, the class generation component 406 may generate the controller mirroring class 408 comprising fields (e.g., a source path field, destination path field, a display name field, etc.), class properties (e.g., a source path class property, a destination path class property, a status class property, etc.), methods (e.g., a set source path method, a get object method, etc.), relationships (e.g., an inheritance rule, an encapsulation rule, or other relationship rule between the controller mirroring object and the storage device object), and/or other information derived from the controller mirroring object definition 412 (e.g., the key value associated with the display name object property). In another example, one or more object properties (e.g., a volume name property), relationship information, and/or other information may be extracted from the storage device object definition 414 by the class generation component for generation of a storage device class 410. In this way, the class generation component 406 may generate the storage device class 410 comprising fields, class properties, methods, relationships, and/or other information derived from the storage device object definition 414.

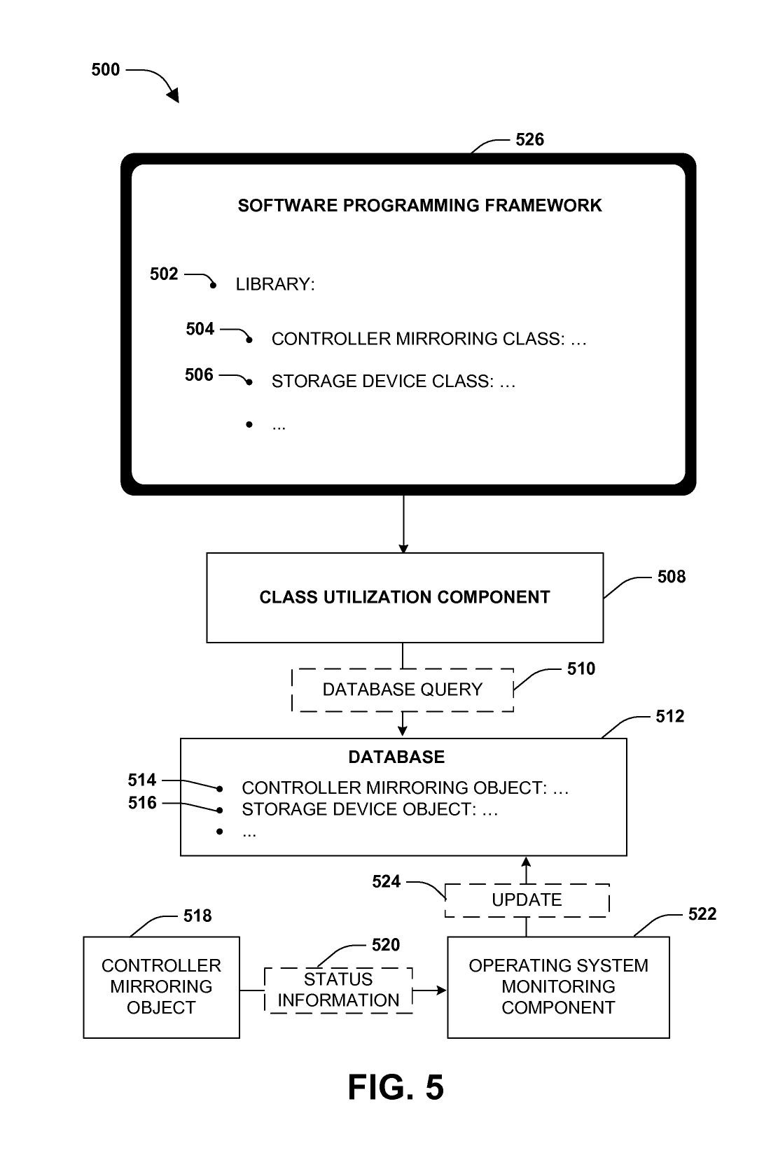

FIG. 5 illustrates an example of a system 500 for utilizing one or more classes generated from management packs. The system 500 comprises a class utilization component 508. The class utilization component 508 may be configured to identify a library 502 comprising a controller mirroring class 504, a storage device class 506, and/or other classes that were generated based upon object definitions extracted from management packs. For example, the controller mirroring class 504 may have been derived from a controller mirroring object definition of a controller mirroring object (e.g., the controller mirroring object may be stored within a database 512 by an operating system monitoring component 522 as a controller mirroring database object 514), and the storage device class 506 may have been derived from a storage device object definition of a storage device object (e.g., the storage device object may be stored within the database 512 by the operating system monitoring component 522 as a storage device object 516). The operating system monitoring component 522 may be configured to monitor objects that are defined within the database 512. For example, the operating system monitoring component 522 may retrieve status information 520 from the controller mirroring object 518 (e.g., a storage controller data mirroring application), which may be used to update 524 the controller mirroring database object 514 within the database 512.

The class utilization component 508 may expose the library 502 through a software programming framework 526 (e.g., .NET) so that a programmer may access the objects stored within the database 512 by the operating system monitoring component 522. For example, the class utilization component 508 may generate a database query to the storage device database object 516 based upon the storage device class 506.

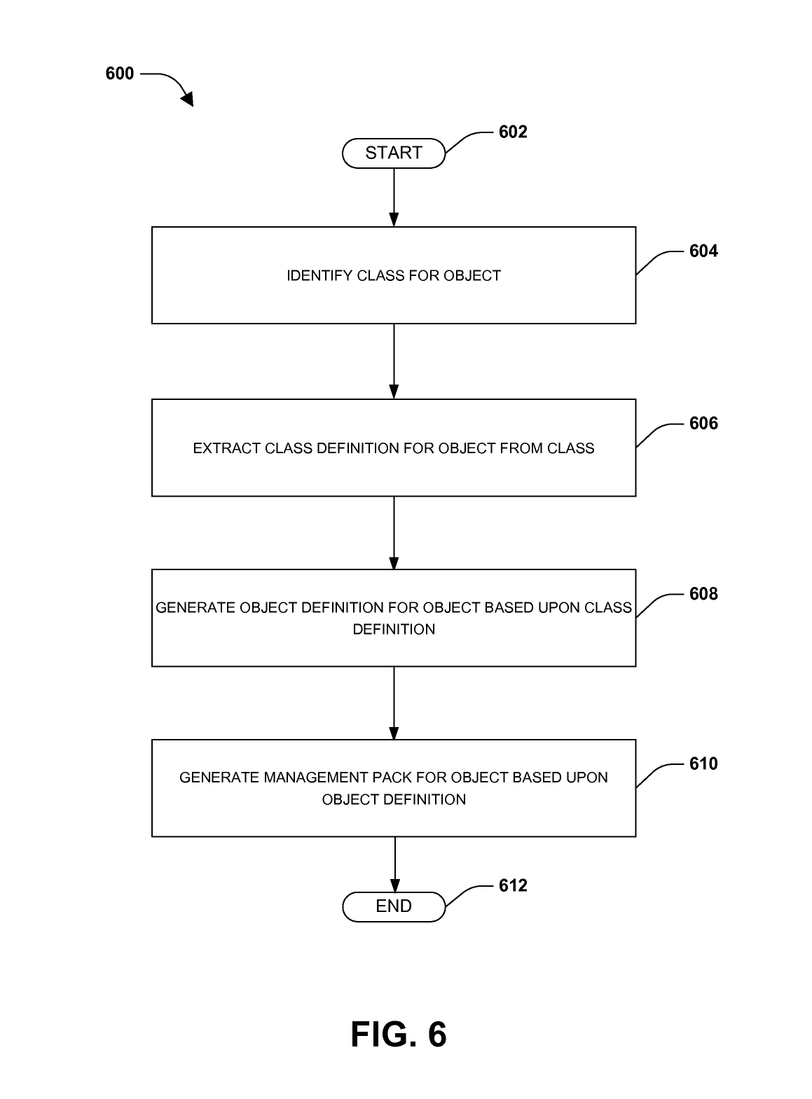

One embodiment of generating a management pack is illustrated by an exemplary method 600 of FIG. 6. At 602, the method starts. At 604, a class for an object may be identified (e.g., a storage device class may model a storage device object describing a storage device). The class may be associated with a software programming framework (e.g., the class may be specified according to a managed code programming language, such as C#, managed by the software programming framework, such as .NET). At 606, a class definition for the object may be extracted based upon the class. At 608, an object definition for the object may be generated based upon the class definition. The object definition may be formatted according to a markup language. The objection definition may be used to create and/or access a storage device object (e.g., a storage device database object) stored within a database by an operating system monitoring component configured to monitor the storage device. At 610, a management pack for the object may be generated based upon the object definition (e.g., the management pack may model the storage device as a storage device object using the markup language). At 612, the method ends.

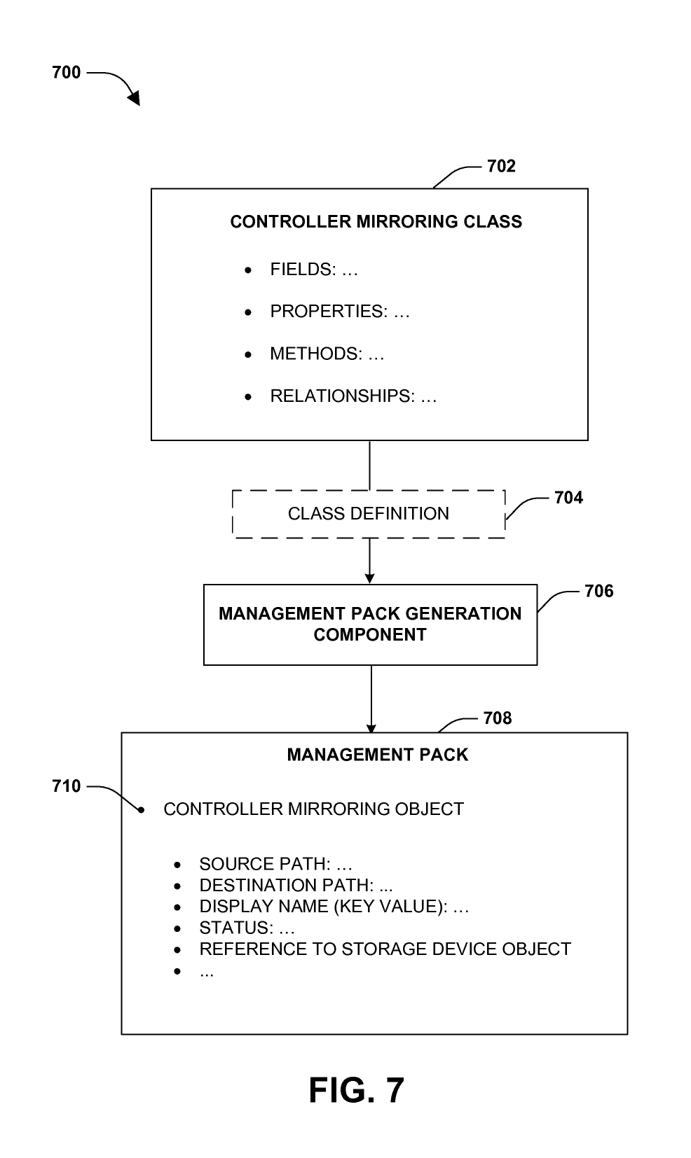

FIG. 7 illustrates an example of a system 700 for generating a management pack 708. The system 700 comprises a management pack generation component 706. The management pack generation component 706 may be configured to identify a class for an object, such as a controller mirroring class 702 modeling a controller mirroring object. The controller mirroring class 702 may be associated with a software programming framework and may be specified according to a managed code programming language.

The management pack generation component 706 may be configured to extract a class definition 704 for the controller mirroring object (e.g., fields, properties, methods, relationships, and/or other information specified by the controller mirroring class 702). The management pack generation component 706 may generate a controller mirroring object definition 710 for the controller mirroring object based upon the class definition 704. The controller mirroring object definition 710 may be formatted according to a markup language. The management pack generation component 706 may generate a management pack 708 based upon the controller mirroring object definition 710. In this way, management packs, formatted according to a markup language and/or consumable by an operating system monitoring component, may be generated based upon classes specified according to a managed code programming language.

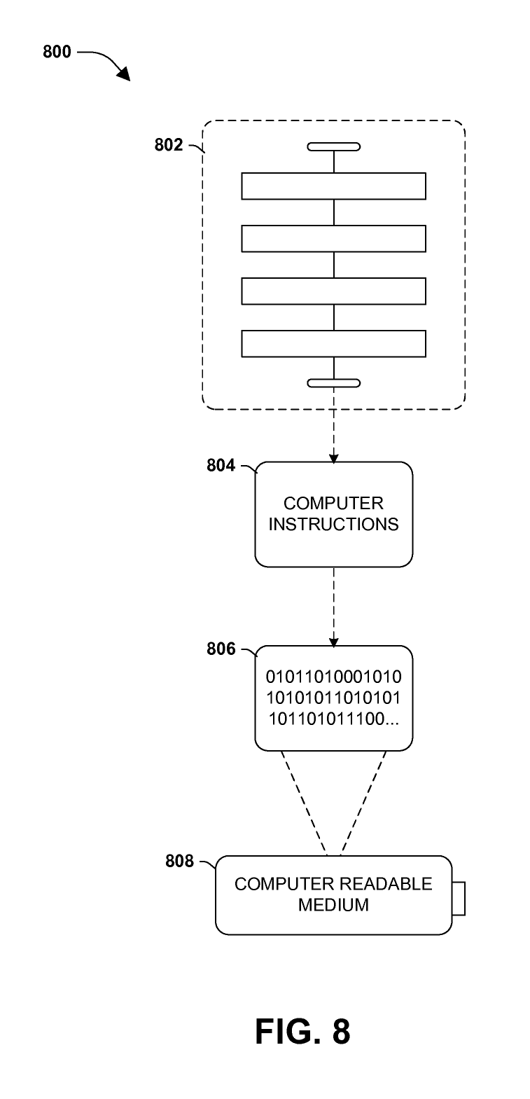

Still another embodiment involves a computer-readable medium comprising processor-executable instructions configured to implement one or more of the techniques presented herein. An example embodiment of a computer-readable medium or a computer-readable device that is devised in these ways is illustrated in FIG. 8, wherein the implementation 800 comprises a computer-readable medium 808, such as a CD-R, DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the processor-executable computer instructions 804 are configured to perform a method 802, such as at least some of the exemplary method 300 of FIG. 3 and/or at least some of the exemplary method 600 of FIG. 6, for example. In some embodiments, the processor-executable instructions 804 are configured to implement a system, such as at least some of the exemplary system 400 of FIG. 4, at least some of the exemplary system 500 of FIG. 5, and/or at least some of the exemplary system 700 of FIG. 7, for example. Many such computer-readable media are contemplated to operate in accordance with the techniques presented herein.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), EEPROM and/or flash memory, CD-ROMs, CD-Rs, CD-RWs, DVDs, cassettes, magnetic tape, magnetic disk storage, optical or non-optical data storage devices and/or any other medium which can be used to store data.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

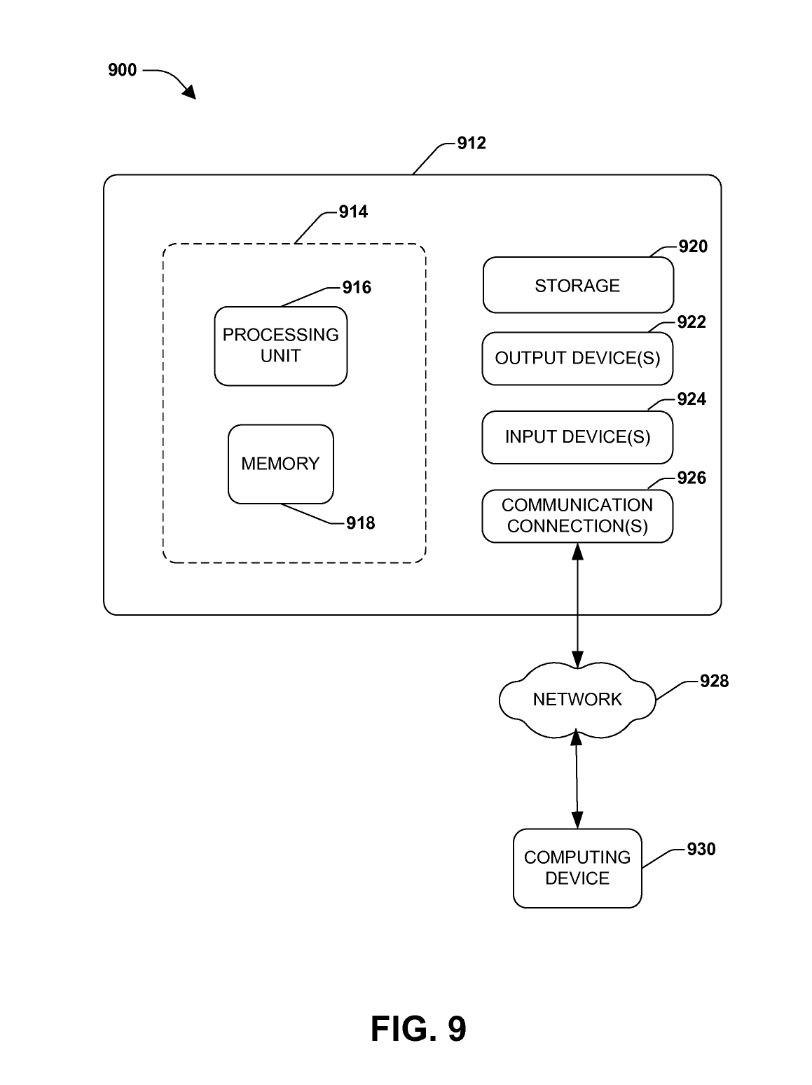

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, and/or the like.

Although not required, embodiments are described in the general context of “computer readable instructions” being executed by one or more computing devices. Computer readable instructions may be distributed via computer readable media. Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 912 configured to implement one or more embodiments provided herein. Computing device 912 may, for example, correspond to 108 in FIG. 1, 110 in FIG. 1 and/or 205 in FIG. 2. Computing device 912 may implement at least some of the exemplary method 300 of FIG. 3 and/or at least some of the exemplary method 600 of FIG. 6, for example. Computing device 912 may implement at least some of the exemplary system 400 of FIG. 4, at least some of the exemplary system 500 of FIG. 5, and/or at least some of the exemplary system 700 of FIG. 7, for example. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 (e.g., 108 in FIG. 1, 110 in FIG. 1 or 205 in FIG. 2) accessible via a network 928 may store computer readable instructions to implement one or more embodiments provided herein (e.g., in FIGS. 3-7). Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A computer readable medium comprising instructions which when executed perform a method, comprising:
accessing, through a software programming framework, a class comprising a class definition for an object, the class definition derived from an object definition, within a management pack, defining the object; and
utilizing the class to access monitoring information associated with the object.

2. The computer readable medium of claim 1, the object comprising a storage operating system, and the method comprising:
monitoring the storage operating system based upon the monitoring information.

3. A method for generating a class, comprising:
retrieving a management pack comprising an object definition of an object;
extracting the object definition from the management pack; and
generating a class for the object based upon the object definition.

4. The method of claim 3, comprising:
determining that the object has a relationship with a second object defined by a second object definition within the management pack;
extracting the second object definition from the management pack;
generating a second class for the second object based upon the second object definition; and
specifying a relationship rule between the class and the second class.

5. The method of claim 3, comprising:
determining that the management pack references a second management pack;
extracting a second object definition from the second management pack;
generating a second class for a second object based upon the second object definition; and
specifying a relationship rule between the class and the second class.

6. The method of claim 3, comprising:
exposing the class through a software programming framework.

7. The method of claim 3, comprising:
utilizing the class to generate a database query to access the object stored within a database by an operating system monitoring component.

8. The method of claim 3, the extracting the object definition comprising enumerating an object property of the object, and the generating a class comprising generating at least one of a field, a class property, or a method for inclusion within the class based upon the object property.

9. The method of claim 3, the management pack formatted according to a markup language, and the extracting comprising:
parsing the markup language to extract an object property of the object.

10. The method of claim 3, the generating a class comprising generating the class according to a managed code programming language.

11. The method of claim 4, the relationship rule comprising at least one of an inheritance rule or an encapsulation rule.

12. The method of claim 3, comprising:
validating the management pack based upon a configuration markup file.

13. The method of claim 12, the validating comprising:
responsive to identifying a naming collision, adding a prefix to at least one of a field, a class property, or a method comprised within the class to resolve the naming collision.

14. The method of claim 3, the generating a class comprising:
generating at least one of an insertion method, a deletion method, a validation method, or a method for inclusion within the class.

15. The method of claim 3, the generating a class comprising:
identifying a key value specified by the object definition; and
generating a set key value method for inclusion within the class based upon the key value.

16. The method of claim 3, comprising:
generating a library based upon the class; and
associating the library with a software programming framework.

17. The method of claim 3, comprising:
identifying a legacy object having a legacy object definition within the management pack; and
preserving the legacy object definition within the management pack.

18. The method of claim 3, comprising:
performing compile-time type-checking for the class.

19. A system for generating a class, comprising:
a class generation component configured to:
retrieve a management pack comprising an object definition of an object;
extract the object definition from the management pack; and
generate a class for the object based upon the object definition.

20. The system of claim 19, comprising:
a class utilization component configured to:
expose the class through a software programming framework; and
utilize the class to generate a database query to access the object stored within a database by an operating system monitoring component.
